(19) United States
(12) Patent Application Publication
(10) Pub. No.: US 2012/0117872 A1
(43) Pub. Date: May 17, 2012

(54) TreeDazzle

(76) Inventor: WILLIAM BRADSHAW, Oak Lawn, IL (US)

(21) Appl. No.: 12/944,906

(22) Filed: Nov. 12, 2010

(51) Int. Cl. A01G 9/02

(52) U.S. Cl. 47/65.8

(57) ABSTRACT

A pot less plant and flower growing and display system that can be placed in a tree limb crotch and other places.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of agriculture. More particularly, the present invention is in the technical field of planting systems for plants and flowers. More particularly, the present invention is in the technical field of pot-less planting systems for plants and flowers.

Conventional planting systems, such as clay plant pots, rigid plastic plant pots, stone containers, wooden gardening containers, and the like, typically must lay flat on the ground or hang from an existing structure.

### SUMMARY OF THE INVENTION

The present invention is a pot-less planting system for plants and flowers that allows planting and displaying plants in places not normally possible with current plant potting devices. The disclosed growing system allows plants and flowers to be grown without the bulky pot or pot hanging devices and can be planted in a variety of different places while conforming to the area which it was planted.

### BRIEF DESCRIPTION OF THE DRAWING

FIG. 1 is a top view of the present invention without dirt or plants added.

FIG. 2 is another top view of the present invention filled with soil and closed.

FIG. 3 is a perspective view of the invention, filled with soil, closed, loaded with plants and flowers, and placed in a tree limb crotch to grow and be displayed.

### DETAILED DESCRIPTION OF THE INVENTION

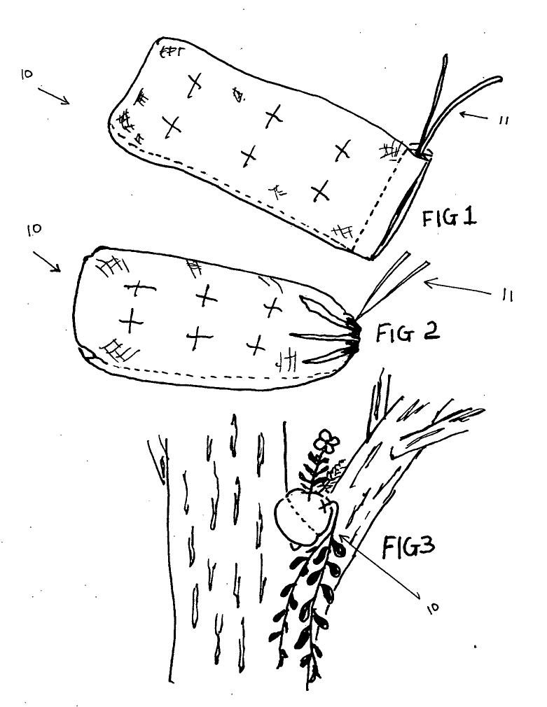

Referring now to the invention in more detail, in FIG. 1, FIG. 2, and FIG. 3, there is shown a disclosed planting system bag 10 which is made of, but limited to, burlap material and a cord 11 at the opening of the bag that is pulled to contain the soil. The disclosed planting system bag or pouch is filled with good quality potting soil and closed with cord 11. Markers on the bag, notated by X's are where the user would slit holes in the bag and install the plants and flowers to be grown and displayed.

The bag may be made of other materials, one such but limited to landscape fabric or even non rigid plastic. The bag may be treated for rot. The bag may be lined with plastic or other moisture retaining material. The bag or pouch may be of different sizes and shapes to better fit the area desired for planting and displaying. The bag or pouch and its plants are easily moved from one tree limb crotch to another location and not limited to trees. The bag may or may not have an integral flap to retain soil. The preferred embodiment that is pictured may have but is not limited to a cord to close the bag. Other means know in the art are available for closing the bag such as but not limited to stapling, twist tying, Velcro, clamps and others or even left open depending on the plants and desire of gardener.

FIG. 2 shows the growing system bag filled with qualify potting soil and closed with integral cord or string.

FIG. 3 shows the growing system bag filled with quality potting soil, loaded with flowers and plants, and placed in the crotch of a tree limb to be grown and displayed.

The advantages of the present invention include, without limitation, that it allows planting in a variety of different places while conforming to the area which it was planted. The disclosed growing system allows plants and flowers to be grown without the bulky pot or pot hanging devices.

In broad embodiment, the present invention is a pot less plant and flower growing and display system that can be placed in a tree limb crotch and other places.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. We claim a pouch or bag used to display and grow plants and or flowers in a tree, bush or other areas of a garden or landscape.
